(19) United States
(12) Patent Application Publication
(10) Pub. No.: US 2006/0256303 A1
(43) Pub. Date: Nov. 16, 2006

(54) Projector

(75) Inventor: Shingo Hamada, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/434,981

(22) Filed: May 16, 2006

(30) Foreign Application Priority Data
May 16, 2005 (JP) 2005-003266

(51) Int. Cl. G03B 3/00

(52) U.S. Cl. 353/101

(57) ABSTRACT

In a circular opening of an upper surface of a chassis, a disk-like zoom adjusting knob and a circular ring-like focus adjusting knob are disposed so as to be rotatable. A zoom interlocking mechanism includes a pinion-rack mechanism and a slide cam. A focus interlocking mechanism includes a pinion-rack mechanism and a slider. The zoom adjusting knob, zoom interlocking mechanism, and zoom adjusting member and the focus adjusting knob, focus interlocking mechanism, and focus adjusting member are fitted to a common body structure to construct a projecting optical unit.

### BACKGROUND

1. Technical Field

The present application relates to a projector, particularly, a projector structured so that a zoom adjustment and a focus adjustment are carried out through manual operations.

2. Description of Related Art

A projector projects an image onto a screen. The projector includes a zoom adjusting function and a focus adjusting function so as to correct quality and size of a projected image. Respective functions are exerted by correcting lens position through advancing and retracting operations of both zoom adjusting member and focus adjusting member. According to the projector, a zoom adjustment and a focus adjustment have been carried out by a rotating operation of a zoom adjusting ring and a focus adjusting ring disposed around a lens barrel housing a plurality of lenses by grasping the same with fingers of the hand.

Meanwhile, a projector system in which a projection lens and a taking lens are arranged at the front face of a rectangular solid-shaped casing body so that focusing position and zoom position of an optical image projected onto a screen by the projection lens can be made arbitrarily variable within a predetermined range has been known (see JP-A2005-24741 (FIG. 1, and paragraphs [0023] and [0024]), for example). In JP-A2005-24741, there is a description to the effect that a zoom ring and a focus ring arranged on the upper surface of the casing body are used when manually operating zoom position and focus position of an image projected and displayed by the projection lens, and the zoom ring and focus ring are formed with the outer circumferential surfaces of these as operating surfaces, and only parts of the operating surfaces are protruded from openings of the upper surface.

### SUMMARY

However, in the projector disposed with a zoom adjusting ring and a focus adjusting ring around a lens barrel, when carrying out manual rotating operations by grasping these rings with fingers of the hand, it is often the case that operator's finger protrude in front of the projection lens and the fingers are projected onto the screen, and in that case, it becomes difficult to carry out a zoom adjustment and a focus adjustment. Therefore, since it is necessary for an operator (user) to carry out a zoom adjustment and a focus adjustment while paying attention so as not to protrude his/her fingers of the hand in front of the projection lens, there has been concern that usability for the operator is inferior.

Moreover, in some cases, simplification of design in the vicinity of an attachment point of the lens barrel to the chassis is spoiled by the zoom adjustment ring and focus adjustment ring disposed therein, or it is pointed out that the zoom adjustment ring and focus adjustment ring become an obstacle when modification of appearance design of the projector to an innovative and novel one is intended.

Meanwhile, in the projector system proposed by JP-A2005-24741, since it has been structured so as to protrude only parts of the operating surfaces formed of the outer circumferential surfaces of the zoom ring and focus ring from the upper surface and operate these by rotating around the horizontal axis, only the parts protruded from the upper surface of the casing are parts of the operating surfaces that can be touched with fingers. Therefore, there is a problem such that it is difficult to carry out an operation to rotate the operating surfaces by pressing fingers thereagainst. On the other hand, in order to protrude the operating surfaces as much as possible from the upper surface of the chassis to improve operationality thereof, since it becomes indispensable to increase the size (diameter) of the zoom ring and focus ring, a problem arises such that a fitting space of other components is sacrificed, and the width of protrusion of the rings from the upper surface of the chassis becomes too large in design.

The present invention has been made in view of the circumstances and problems described above, and it is an object of the invention to provide a projector that easily allows eliminating such a situation that fingers of the hand can be projected onto a screen when carrying out a zoom adjustment and a focus adjustment through rotating manual operations, simplifying design in the vicinity of an attachment point of the lens barrel to the chassis, and making it easy to modify appearance design of said projector to a novel one.

In addition, it is an object of the invention to provide a projector that can improve operationality when carrying out rotating manual operations by pressing the operating surfaces of a zoom adjusting knob and a focus adjusting knob with fingers without sacrificing a fitting space of other components or adversely affecting appearance design of said projector.

According to an aspect of the invention, a projector is one for which, in an opening of a chassis to which a lens barrel has been attached, a zoom adjusting knob and a focus adjusting knob are disposed in a condition where the whole of respective operating surfaces that are provided for these and are orthogonal to rotation axes of these faces the outside of the chassis, constructed so that a zoom adjustment and a focus adjustment are carried out through rotating manual operations of the zoom adjusting knob and focus adjusting knob.

With this construction, since an attachment point of the lens barrel and an attachment point of the zoom adjusting knob and focus adjusting knob are to be positioned distant at separate points, when carrying out a zoom adjustment and a focus adjustment through rotating manual operations, operationality thereof is improved because there is no room for such a situation that it becomes difficult to carry out those adjusting operations as fingers of the hand are projected onto a screen, and at the same time, such an effect that design in the vicinity of the attachment point of the lens barrel to the chassis is simplified and it becomes easy to modify appearance design of said projector to a novel one can be provided. In addition, since the whole of the flat operating surfaces formed by the surfaces of the zoom adjusting knob and focus adjusting knob is disposed in a manner facing the outside of the chassis, it becomes possible to increase the operating surfaces of these respective knobs without adversely affecting appearance design of said projector and without sacrificing a fitting space of other components so that operationality thereof is improved. The “operating surfaces that are orthogonal to rotation axes” mentioned here mean that, when fabricating the zoom adjusting knob and focus adjusting knob of plate-like or column-like members that are rotated around axes, plate surfaces or end faces of those members are equivalent to operating surfaces, and does not mean that the operating surfaces have no unevenness such as embossing or ribs. Accordingly, even when an embossing finish is applied to or ribs are formed on operating surfaces to enhance their performance of rotating manual operations, said operating surfaces are included in the “operating surfaces that are orthogonal to rotation axes.”

The respective operating surfaces of the zoom adjusting knob and focus adjusting knob may be positioned flush or almost flush with an upper surface of the chassis and face the outside of the chassis. According thereto, since the zoom adjusting knob and focus adjusting knob do not protrude upward from the upper surface of the chassis, not only does it become easy to modify appearance design of said projector to a nonconventional novel one, it becomes possible to organize appearance design of said projector into a simple design with less unevenness.

One of the members of the disk-like first member concentrically disposed and second member concentrically disposed with the first member may be formed as a zoom adjusting knob, and the other member may be formed as a focus adjusting knob. The zoom adjusting knob and focus adjusting knob can be disposed in a single opening of the chassis, so that an installation space of these two types of knobs can be kept narrow, and moreover, since the zoom adjusting knob and focus adjusting knob that are generally operated at the same time are positioned at an identical point, operationality thereof is improved.

It may be possible to employ a construction that a zoom adjusting member that is advanced and retracted back and forth through a zoom adjusting operation is linked with the zoom adjusting knob via a zoom interlocking mechanism, and the zoom interlocking mechanism includes a slide cam and a movable body that is provided on the zoom adjusting member and is advanced and retracted back and forth by a transverse motion of the slide cam. Moreover, it is possible to employ a construction that a focus adjusting member that is advanced and retracted back and forth through a zoom adjusting operation is linked with the focus adjusting knob via a focus interlocking mechanism, and the focus interlocking mechanism includes a gear that is provided on the focus adjusting member and advances and retracts the focus adjusting member by a rotation and a slider provided with a rack that is linked in an interlocking manner with the focus adjusting knob via a pinion-rack mechanism that converts a rotational motion to a linear motion and rotates the gear through the transverse motion. When these constructions are employed, by rotating manual operations of the zoom adjusting knob and focus adjusting knob, a rotational motion of those respective knobs is converted to an advancing and retracting motion of the zoom adjusting member and focus adjusting member via the respective interlocking mechanisms, so that a zoom adjustment and a focus adjustment are appropriately and reliably carried out. In addition, the number of components necessary to construct the zoom interlocking mechanism and focus interlocking mechanism can be kept small.

The zoom adjusting knob, zoom interlocking mechanism, and zoom adjusting member and the focus adjusting knob, focus interlocking mechanism, and focus adjusting member may be fitted to a body structure common to these to construct a projecting optical unit. Since it becomes possible to dispose the zoom adjusting knob and focus adjusting knob in the opening of the chassis by only fitting said projecting optical unit to the chassis, the assembling step of said projector is simplified.

In a projector disposed with a zoom adjusting ring and a focus adjusting ring around a lens barrel, in place of omitting the zoom adjusting ring and focus adjusting ring, a zoom adjusting knob formed of a disk-like first member and a focus adjusting knob formed of a circular ring-like second member disposed concentrically with the first member are disposed so as to be rotatable around a vertical axis in a circular opening provided at one point of an upper plate portion of a chassis to which the lens barrel has been attached, the whole of operating surfaces formed of respective surfaces of the zoom adjusting knob and focus adjusting knob are positioned flush or almost flush with an upper surface of the chassis and faces the outside of the chassis, a zoom interlocking mechanism that links the zoom adjusting knob and a zoom adjusting member that is advanced and retracted back and forth through a rotating manual operation of the zoom adjusting knob includes a movable body provided on the zoom adjusting member and a slide cam that is linked in an interlocking manner with the zoom adjusting knob via a pinion-rack mechanism that converts a rotational motion to a linear motion and advances and retracts the movable body back and forth through the transverse motion, a focus interlocking mechanism that links the focus adjusting knob and a focus adjusting member that is advanced and retracted back and forth through a rotating manual operation of the focus adjusting knob includes a gear that is provided on the focus adjusting member and advances and retracts the focus adjusting member back and forth by a rotation and a slider provided with a rack that is linked in an interlocking manner with the focus adjusting knob via a pinion-rack mechanism that converts a rotational motion to a linear motion and rotates the gear through the transverse motion, and the zoom adjusting knob, zoom interlocking mechanism and zoom adjusting member, and the focus adjusting knob, focus interlocking mechanism and focus interlocking member are fitted to a common body structure to construct a projecting optical unit. Effects will be described in detail with reference to the following embodiment.

Since the zoom adjusting knob and focus adjusting knob are displaced at a point distant from the attachment point of the lens barrel, for example, at one point of the upper surface of the chassis, there is no room for such a situation that fingers of the hand are projected onto a screen when carrying out a zoom adjustment and a focus adjustment through rotating manual operations, so that operationality for an operator is greatly improved. Moreover, since the fact that the above-described respective knobs are disposed in the opening of the chassis at a point distant from the lens barrel is useful for making it easier to simplify design in the vicinity of the attachment point of the lens barrel to the chassis, making appearance design of said projector innovative and furthermore, modifying appearance design of said projector to an unconventional novel one, there is an advantage for the operator such that it becomes possible to use a projector excellent in operationality and moreover in an innovative design different from that of the conventional projector. In addition, although the zoom adjusting knob and focus adjusting knob are provided at a point different from that of the conventional projector, since rotations of those knobs owing to rotating manual operations are accurately transmitted to the zoom adjusting member and focus adjusting member via the pinion-rack mechanism, slide cam, movable body, and the like, it becomes possible to accurately carry out a zoom adjustment and a focus adjustment. Furthermore, it becomes possible to improve operationality when carrying out a rotating operation by pressing the operating surfaces of the zoom adjusting knob and focus adjusting knob with fingers without sacrificing a fitting space of other components or adversely affecting appearance design of said projector.

### BRIEF DESCRIPTION OF THE DRAWINGS

FIG. 1 is a schematic external perspective view of a projector according to an embodiment;

FIG. 2 is a schematic cross-sectional view of a main part of the projector;

FIG. 3 is a schematic plan view of the main part; and

FIG. 4 is a schematic plan view of another main part.

### DESCRIPTION OF THE EMBODIMENTS

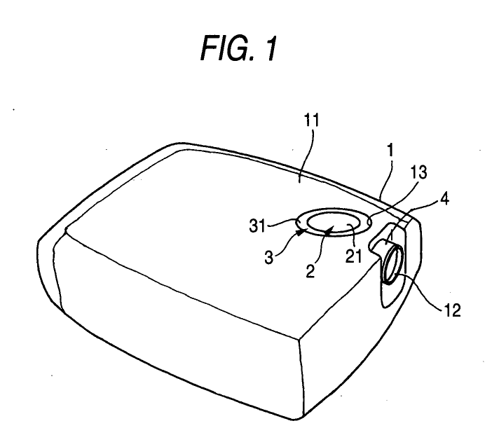

FIG. 1 is a schematic external perspective view of a projector according to an embodiment. As can be analogized from FIG. 1, in the projector of the embodiment, a chassis 1 thereof is divided into a bottom case, a top case, a front case, and the like united by fitting to each other, a projecting port 12 or the like is provided at a front face of the chassis 1, and a zoom adjusting knob 2 formed of a disk-like first member and a focus adjusting knob 3 formed of a circular ring-like second member are disposed in a circular opening 13 provided at a point of an upper plate portion 11 of the chassis 1, and the circular ring-like focus adjusting knob 3 is concentrically disposed at the outer side of the disk-like zoom adjusting knob 2. In addition, the whole of operating surfaces 21 and 31 of these respective knobs 2 and 3 is in a form not protruded from the upper surface of the chassis 1 so much, that is, positioned flush or almost flush with the upper surface of the chassis 1 and facing the outside thereof, and the diameters of those operating surfaces 21 and 31 are determined at sizes sufficient to secure a satisfactory operationality.

These respective knobs 2 and 3 are disposed in the opening 13 of the chassis 1 in place of disposing a zoom adjusting ring and a focus adjusting ring around a lens barrel 4. And, these respective knobs 2 and 3 are capable of individual rotating manual operations around the vertical axis, and when operating the zoom adjusting knob 2, an operation to rotate the same in a manner pressing a finger against the top of the disk-like operating surface 21 thereof is carried out, and when operating the focus adjusting knob 3, an operation to rotate the same in a manner pressing a finger against the top of the circular ring-like operating surface 31 is operated, therefore, in this point, the fact that the respective knobs 2 and 3 are disposed in the opening 13 on the upper surface of the chassis 1 is useful in improving operationality. Here, it is also possible to enhance performance of rotating manual operations by adding embossing or ribs to the operating surface 21 of the zoom adjusting knob 2 and operating surface 31 of the focus adjusting knob 3.

In this projector, by a rotating manual operation of the zoom adjusting knob 2, the size of a projected image to be displayed on a screen in front of the projecting port 12 formed by the lens barrel 4 is corrected, and by a rotating manual operation of the focus adjusting knob 3, quality (focal point quality) of a projected image to be displayed on the same screen is corrected. Such rotating manual operations of the respective knobs 2 and 3 are operations performed by an operator by pressing his/her fingers of the hand against the operating surfaces 21 and 31 of the respective knobs 2 and 3, and since the operating point is distant from the lens barrel 4, no such situation that fingers of the hand of the operator protrude in front of the projecting port and are displayed on the screen can happen during operation. Therefore, there is an advantage for the operator such that it becomes possible to easily and accurately carry out the rotating manual operations of the respective knobs 2 and 3 for a zoom adjustment and a focus adjustment without paying special attention. Moreover, since the whole of the operating surfaces 21 and 31 of the respective knobs 2 and 3 is disposed in the opening 13 of the chassis 1, there is an advantage such that it becomes unnecessary to provide a zoom adjusting ring and a focus adjusting ring around the lens barrel 4 so that design around the lens barrel 4 is simplified, and at the same time, appearance design of said projector becomes an unprecedented novel design so that not only is simplicity in appearance improved, but also appearance design of said projector does not change so much even when those operating surfaces 21 and 31 are enlarged to improve operationality.

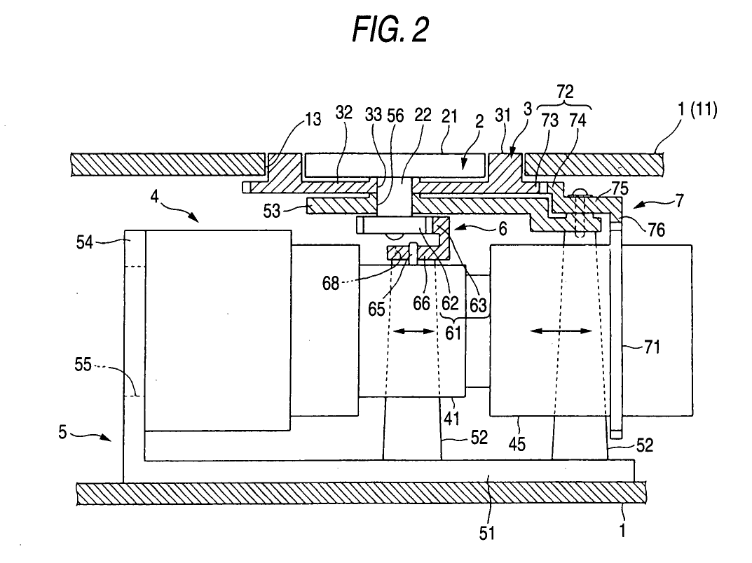

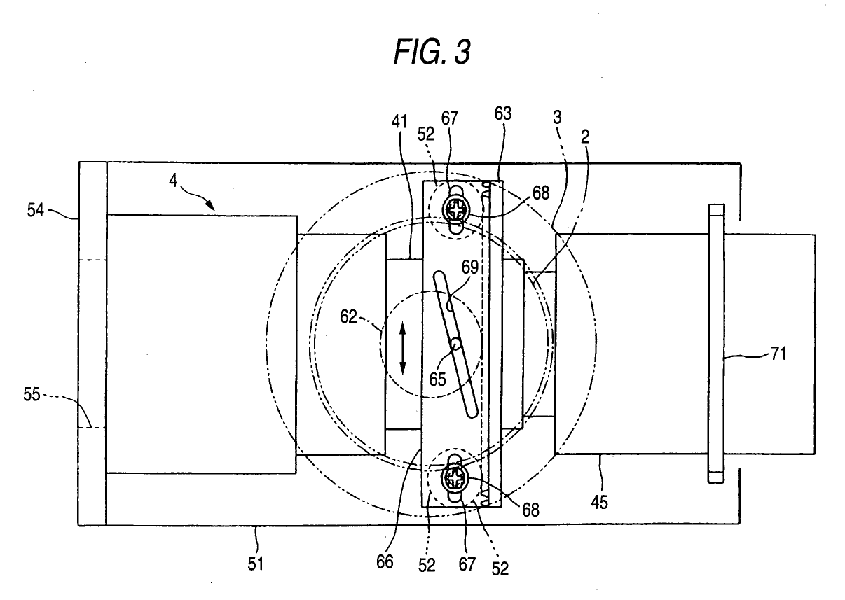

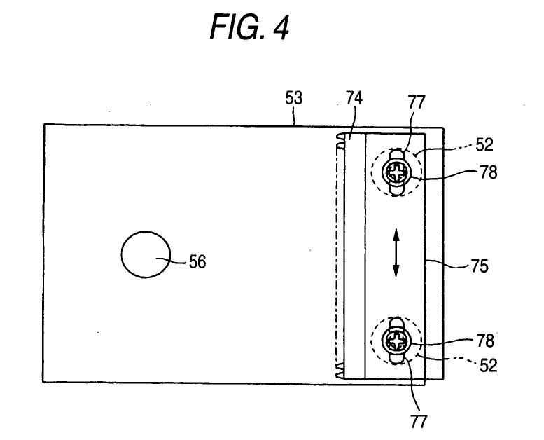

FIG. 2 is a schematic cross-sectional view of a main part of the same projector, FIG. 3 is a schematic plan view of the same main part, and FIG. 4 is a schematic plan view of another main part.

In FIG. 2, reference numeral 5 denotes a body structure constructed in a framing form, in which a bottom plate 51 is provided, and in addition to a supporting plate 53 being fixed to top portions of predetermined posts 52 . . . erected from a plurality of points of the bottom plate 51, the lens barrel 4 is attached to an attaching plate 54 erected from an end portion of the bottom plate 51, and a light intake port 55 is provided in the attaching plate 54. And, a disk-like base portion 32 provided for the focus adjusting knob 3 is disposed on the supporting plate 53, and a vertical axis 22 integrated with the zoom adjusting knob 2 is disposed in a manner passing through an axis hole 33 of the base portion 32 and a bearing hole 56 provided in the supporting plate 53, whereby the respective knobs 2 and 3 are made individually freely rotatable around the vertical axis.

The above-described lens barrel 4 includes a zoom adjusting member 41 that can be advanced and retracted back and forth by being guided by an unillustrated guide and a focus adjusting member 45 that can be advanced and retracted back and forth similarly by being guided by another guide, in which a zoom adjustment is carried out through a back-and-forth advancing and retracting operation by the zoom adjusting member 41, and a focus adjustment is carried out through a back-and-forth advancing and retracting operation of the focus adjusting member 45. And, the zoom adjusting knob 2 and zoom adjusting member 41 are linked by a zoom interlocking mechanism 6, and the focus adjusting knob 3 and focus adjusting member 45 are linked by a focus interlocking mechanism 7.

The zoom interlocking mechanism 6 includes a pinion-rack mechanism 61 that converts a rotational motion to a linear motion, a pin-like movable body 65 provided on the zoom adjusting member 41, and a slide cam 66 that advances and retracts the movable body 65 back and forth through a transverse motion. The above-described pinion-rack mechanism 61 is composed of a pinion 62 concentrically screw-fitted to a lower end of the vertical axis 22 integrated with the zoom adjusting knob 2 and a rack 63 integrally provided on the above-described slide cam 66 and engaged with the pinion 62. In addition, the slide cam 66 is, by screwing attaching screws 68 and 68 that have been inserted to penetrate through guide holes 67 and 67 being slots provided at both left and right end portions thereof as in FIG. 3 into the top portions of the predetermined posts 52 and 52 of the body structure 5, attached to these posts 52 and 52 so that a transverse motion is possible, and the above-described pin-like movable body 65 is freely slidably joined so as to mate with a biased cam face 69 formed on that slide cam 66. Accordingly, when an operator carries out a rotating manual operation of the operating surface 21 of the zoom adjusting knob 2 by pressing his/her finger thereagainst, that rotation of the knob 2 is converted to a linear motion via the pinion-rack mechanism 61 and transmitted to the slide cam 66, and through that transverse motion of the slide cam 66, the movable body 65 advances and retracts back and forth together with the zoom adjusting member 41 so that a zoom adjustment is carried out.

Next, the focus interlocking mechanism 7 includes a gear 71 that is provided on the focus adjusting member 45 and advances and retracts the focus adjusting member 45 back and forth by a rotation, a pinion-rack mechanism 72 that converts a rotational motion to a linear motion, a slider 75 integrally provided with a rack 76 engaged with the above-described gear 71. And, the pinion-rack mechanism 72 is composed of a pinion 73 integrally formed at an outer circumferential portion of the base portion 32 of the focus adjusting knob 3 and a rack 74 integrally provided on the above-described slider 75 and engaged with the pinion 73. In addition, the slider 75 is, by screwing attaching screws 78 and 78 that have been inserted to penetrate through guide holes 77 and 77 being slots provided at both left and right end portions thereof as in FIG. 4 into the top portions of the predetermined posts 52 and 52 of the body structure 5, attached to these posts 52 and 52 so that a transverse motion is possible. Accordingly, when an operator carries out a rotating manual operation of the operating surface 31 of the focus adjusting knob 3 by pressing his/her finger thereagainst, that rotation of the knob 3 is converted to a linear motion via the pinion-rack mechanism 72 and transmitted to the slider 75, and that transverse motion of the slider 75 is transmitted to the gear 71 via the rack 71 to rotate the wheel 71, and the focus adjusting member 45 advances and retracts back and forth so that a focus adjustment is carried out.

In the present embodiment, the zoom adjusting knob 2, zoom interlocking mechanism 6, focus adjusting knob 3, focus interlocking mechanism 7, and lens barrel 4 including the zoom adjusting member 41 and focus adjusting member 45 are all fitted to the single structure body 5 to construct a projecting optical unit. Therefore, after fitting this projecting optical unit to the bottom case that forms the chassis 1, by only carrying out an assembling step of covering the top case from the top thereof for fitting, it becomes possible to dispose the zoom adjusting knob 2 and focus adjusting knob 3 in the opening 13 of the chassis 13. Accordingly, in comparison with a case where the zoom adjusting knob 2 and focus adjusting knob 3 are individually and independently fitted, the number of assembling steps can be reduced so that the assembling step of said projector is simplified.

In the embodiment described in the above, the zoom adjusting knob 2 and focus adjusting knob 3 have been disposed in the circular opening 13 formed at one point of the chassis 1, however, it is also possible to dispose these respective knobs in openings formed at two separate points of the chassis. In addition, it is also possible to form a zoom adjusting knob in a circular ring form and form a focus adjusting knob in a disk form and then to concentrically dispose the zoom adjusting knob at the outer side of the focus adjusting knob.

What is claimed is:

1. A projector capable of being provided with a zoom adjusting ring and a focus adjusting ring which are disposed around a lens barrel, comprising:
a zoom adjusting knob formed of a disk-like first member;
a focus adjusting knob formed of a second member which is disposed concentrically with the first member, the second member having a circular ring-like shape, wherein the zoom adjusting knob and the focus adjusting knob are disposed so as to be rotatable around a vertical axis in a circular opening provided at one point of an upper plate portion of a chassis to which a lens barrel has been attached, in place of omitting the zoom adjusting ring and the focus adjusting ring,
wherein a whole of operating surfaces is formed of respective surfaces of both the zoom adjusting knob and focus adjusting knob,
wherein the whole of operating surfaces is positioned flush or almost flush with an upper surface of the chassis,
wherein the whole of operating surfaces faces an outside of the chassis,
the projector further comprising;
a zoom interlocking mechanism linking the zoom adjusting knob and a zoom adjusting member that is advanced and retracted back and forth through a rotating manual operation of the zoom adjusting knob, the zoom interlocking mechanism comprising;
a movable body provided on the zoom adjusting member; and
a slide cam being linked in an interlocking manner with the zoom adjusting knob via a pinion-rack mechanism that converts a rotational motion to a linear motion, the slide cam advancing and retracting the movable body back and forth through a transverse motion,
a focus interlocking mechanism linking the focus adjusting knob and a focus adjusting member that is advanced and retracted back and forth through a rotating manual operation of the focus adjusting knob, the focus interlocking mechanism comprising;
a gear being provided on the focus adjusting member, the gear advancing and retracting the focus adjusting member back and forth by a rotation; and
a slider comprising; a rack linked in an interlocking manner with the focus adjusting knob via a pinion-rack mechanism, the rack converting a rotational motion to a linear motion, and the rack rotating the gear through a transverse motion,
wherein a common body structure includes the zoom adjusting knob, the zoom interlocking mechanism, the zoom adjusting member, the focus adjusting knob, the focus interlocking mechanism and the focus interlocking member, and
wherein the common body structure constructs a projecting optical unit.

2. A projector comprising;
a lens barrel;
a chassis having a opening to which the lens barrel is attached;
a zoom adjusting knob having an operating surface orthogonal to a rotation axis of the zoom adjusting knob, the operating surface facing outside of the chassis; and
a focus adjusting knob having an operation surface orthogonal to a rotation axis of the focus adjusting knob, the operating surface facing outside of the chassis, wherein a zoom is adjusted through a rotating manual operation of the zoom adjusting knob, and
wherein a focus is adjusted through a rotating manual operation of the focus adjusting knob.

3. The projector according to claim 2, wherein the respective operating surfaces of both the zoom adjusting knob and focus adjusting knob are positioned flush or almost flush with an upper surface of the chassis.

4. The projector according to claim 2, further comprising;
a first member concentrically disposed, the first member having a disk-like shape; and
a second member concentrically disposed with the first member, wherein one of the first and second members is the zoom adjusting knob, and the other of the first and second members is the focus adjusting knob.

5. The projector according to claim 4, wherein the zoom adjusting knob links through a zoom interlocking mechanism a zoom adjusting member which is advanced and retracted back and forth, and
wherein the zoom interlocking mechanism comprises:
a slide com; and
a movable body being provide on the zoom adjusting member, the movable body being advanced and retracted back and forth by a transverse motion of the slide com.

6. The projector according to claim 4, wherein the focus interlocking mechanism links through a focus interlocking mechanism a focus adjusting member which is advanced and retracted back and forth, and
wherein the focus interlocking mechanism comprises:
a gear being provided on the focus adjusting member, and the gear advancing and retracting back and forth the focus adjusting member by a rotation; and
a slider comprising;
a rack linking in an interlocking manner with the focus adjusting knob via a pinion-rack mechanism and converting a rotational motion to a linear motion and rotating the gear through the transverse motion.

7. The projector according to claim 5, wherein the zoom adjusting knob, the zoom interlocking mechanism, the zoom adjusting member, the focus adjusting knob, the focus interlocking mechanism, and the focus adjusting member are fitted to a body structure common so as to construct a projecting optical unit.
